(19) United States
(12) Patent Application Publication
(10) Pub. No.: US 2019/0378115 A1
(43) Pub. Date: Dec. 12, 2019

(54) ELECTRONIC PAYMENT APPARATUS

(71) Applicant: Christopher John HAMILTON, Cowbridge, South Wales (GB)

(72) Inventor: Christopher John HAMILTON, Cowbridge, South Wales (GB)

(21) Appl. No.: 16/486,743

(22) PCT Filed: Feb. 16, 2018
(86) PCT No.: PCT/GB2018/050413

§ 371 Date: Aug. 16, 2019

(30) Foreign Application Priority Data
Feb. 20, 2017 (GB) 1702706.1

(51) Int. Cl. G06Q 20/32; G06Q 20/38; G06Q 20/20; G06Q 20/42

(52) U.S. Cl. CPC G06Q 20/3274; G06Q 20/385; G06Q 20/42; G06Q 20/3227; G06Q 20/204

(57) ABSTRACT

The present invention concerns electronic payment apparatus. More particularly, but not exclusively, this invention concerns electronic payment apparatus, and methods and systems for making electronic payments. An apparatus for conducting a financial transaction is provided. The apparatus comprises a smart device with an application. The smart device has a first configuration in which the application displays account information, and a second configuration in which the smart device displays an optically readable transaction authorisation code. The transition between the first configuration and second configuration is effected by changing the orientation of the smart device.

### FIELD OF THE INVENTION

The present invention concerns electronic payment apparatus. More particularly, but not exclusively, this invention concerns electronic payment apparatus, and methods and systems for making electronic payments.

### BACKGROUND OF THE INVENTION

There are various ways in which someone may pay for goods and services without the requirement for carrying cash, or the potential trust issues associated with issuing and honouring a cheque. The most widespread method is the use of a payment card, often with a verification step including a personal identification number (PIN) or customer signature. Recent developments in near field communication (NFC) and radio frequency identification (RFID) have resulted in payment cards being used for contactless payment, where a card is presented to a reader and payment is automatically taken without the need for an identification step. Smart devices, such as smart phones, smart tablets, and smart watches, are also being used in a similar way, making use of NFC techniques to allow users to make contactless payments by presenting the smart device to a suitable reader. However, there is a risk that fraudulent payments may be taken by criminals using card reading devices without the knowledge of the card owner, or via a criminal obtaining the data from a payment enabled smart device.

The present invention seeks to mitigate the above-mentioned problems. Alternatively or additionally, the present invention seeks to provide an improved method and apparatus for making electronic payments.

### SUMMARY OF THE INVENTION

The present invention provides, according to a first aspect, an apparatus for conducting a financial transaction, the apparatus comprising a smart device with an application,

the smart device having a first configuration in which the application displays account information, and a second configuration in which the smart device displays an optically readable transaction authorisation code,

wherein the transition between the first configuration and second configuration is effected by changing the orientation of the smart device.

The smart device may be a smart phone, a smart tablet, or a smart watch. The smart device may be any suitable device, which can communicate via an electronic network, for example via Bluetooth®, WI-FI, near field communication, radio frequency identification, 3G, 4G, etc.

The optically readable transaction authorisation code may be a barcode, a quick-response (QR) code, or any other suitable configuration of display.

The smart device may be configured such that changing the orientation of the smart device causes the application to generate the optically readable transaction authorisation code.

The smart device may be configured to communicate with a remote server in response to the orientation of the smart device being changed.

The smart device may be arranged to be in the first configuration when in a portrait orientation. The smart device may be arranged to be in the second configuration when in the landscape orientation.

The smart device may be configured such that the application may only be opened in response to a unique security input by a user. The unique security input may be a PIN code or a biometric identifier such as a fingerprint, or other designated input mechanism.

As the apparatus generates an optically readable transaction authorisation code, the apparatus is not vulnerable to skimming devices, such as those that use NFC and RFID communication methods. The transaction authorisation code may be a single use, unique, code, so repeat transactions are not fraudulently authorised. The transaction authorisation code may include a 16 digit account number.

According to a second aspect, the invention provides a method of conducting a financial transaction using a smart device, the method comprising:

providing a smart device including an application, the application including financial data,

with the smart device in a first orientation, a user opening the application in a first configuration, the first configuration such that financial information is displayed by the smart device,

the user changing the orientation of the smart device into a second, different, orientation, thereby moving the smart device into a second configuration such that an optically readable transaction authorisation code is displayed by the smart device,

the user presenting the smart device in the second configuration to a point of sale optical reader,

the point of sale optical reader reading the optically readable transaction authorisation code, whereby a financial transaction between the smart device and point of sale optical reader is authorised.

According to a third aspect of the invention, there is provided a payment system, the payment system comprising:

a smart device including an application, wherein the application is configured such that in response to a user input, the application generates and displays an optically readable transaction authorisation code on the smart device,

a retail unit, the retail unit comprising a point of sale reading device, the reading device configured to read optically readable transaction authorisation codes.

The retail unit may be configured to send an electronic signal to the smart device regarding a transaction. The signal may include the value of the transaction, and prompt the smart device to seek an authorisation input from the user of the smart device. The smart device may be configured, in response to an authorisation input from the user of the smart device, to send an electronic signal to the retail unit. The electronic signal sent by the smart device may represent an electronic transfer of funds between the smart device and the retail unit. In an alternative arrangement, the smart device may make the electronic transfer of funds without requiring an authorisation input from the user of the smart device. This may be dependent on the size of the transfer of funds, with a threshold level under which an additional authorisation step is not required, and over which the additional authorisation step is required.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIG. 1 shows an example process for setting up a customer account and configuring a smart device for making electronic payments;

FIG. 2 shows an example payment process;

FIG. 3 shows how a retailer may set up an account and process an electronic payment;

FIG. 4 shows an example electronic payment system; and

FIGS. 5A and 5B show a smart device for making electronic payments.

### DETAILED DESCRIPTION

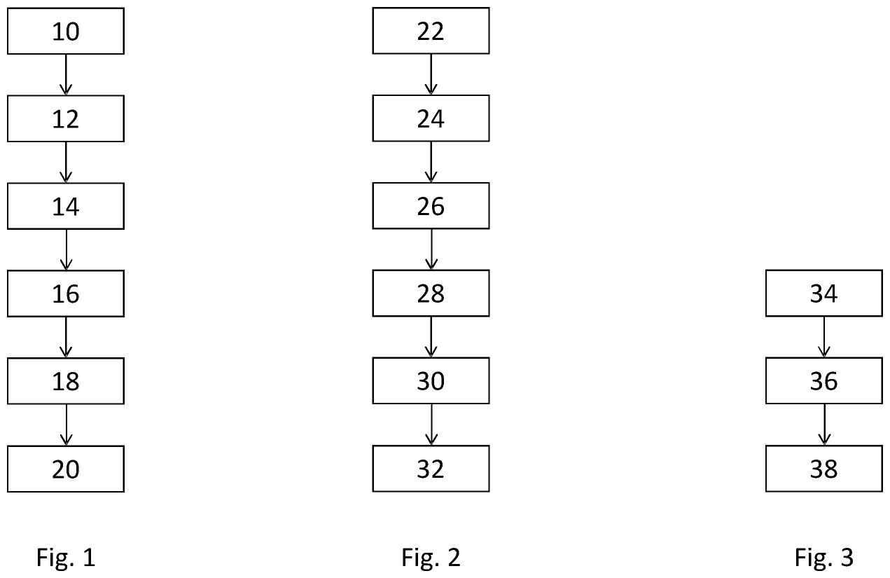

FIG. 1 shows an example process for setting up an account and configuring a smart device for making electronic payments. In this example, the smart device is a mobile phone, but it could be any other suitable smart device, such as a tablet computing device or a smart watch.

The process comprises the step 10 of a user applying for a payment account from an account provider. Assuming the application meets the criteria set by the account provider, the next step 12 is the account application being accepted by the account provider. The next step 14 initiates the configuration of the mobile phone of the user, as a one-time password is issued by the account provider to the account holder. Once the mobile phone has been verified as that of the account holder, via use of the one-time password, the account holder can download an application 16, comprising the account details of the account holder. The account details include a 16 digit account number. The account holder then transfers cash 18 from an external bank account to the application installed on the mobile phone. The cash is stored in the application as virtual cash, as if the mobile phone device is an electronic wallet. Once the application has been loaded with cash, the mobile phone is ready for use 20 as a payment apparatus. The account holder may also be issued with a conventional payment card, including the 16 digit account number, an expiry date, and a card verification value (CCV).

FIG. 2 shows the process of an account holder using their mobile phone as a payment apparatus, and conducting a financial transaction using the phone. As a first step 22, the user opens the application on their mobile phone. This step may include an identification step such as a PIN being entered, or biometric data, such as a fingerprint, being checked. In the first, portrait orientation, the mobile phone displays account information to the account holder, including the amount of cash present in the account, and one or more previous transactions which have taken place on the account. In order to initiate a transaction, the account holder rotates the mobile phone into a landscape orientation 24. The application then generates a unique QR code, which is displayed on the screen of the mobile phone 26. The unique QR code includes the 16 digit account number of the account holder. The account holder then presents the mobile phone to a point of sale reader of a retailer 28, at which stage the point of sale reader of the retailer reads the QR code. The point of sale reader of the retailer will recognise the 16 digit account number as identifying an account held with the account provider. The retailer enters the transaction value into their till, and this value appears on the screen of the account holder's mobile phone, via an electronic signal sent from the point of sale reader of the retailer to the mobile phone. At this point, the application running on the mobile phone asks the account holder to confirm the transaction 30, adding a further level of security to the system. In an alternative embodiment, the account holder may enter the transaction value into their phone. Once the account holder has confirmed the transaction is legitimate, an electronic transfer of the virtual cash from the mobile phone application to a corresponding virtual account of the retailer takes place 32. The electronic transfer may be by any suitable electronic communication technique, including Bluetooth <®), NFC, or RFID. The application running on the mobile phone logs the transaction, amends the funds available in the user account, and attaches a receipt to the transaction. This allows the account holder to identify the transaction when the application is configured in the first orientation, and the account details are provided on screen.

FIG. 3 shows a process diagram for a retailer conducting a transaction using the above described payment system. The retailer sets up an account with the account provider 34. As the account is set up, a point of sale reader is provided to the retailer, the point of sale retailer also comprising a virtual wallet to contain funds transferred from the account holder's mobile phone to the retailer 36. The retailer may view the contents of their virtual wallet at any time, and also transfer the funds from the virtual wallet to a conventional high street bank account. The transfer step 36 takes place instantaneously, and directly between the account holder's mobile phone and the retailer's point of sale reader. This is in contrast to conventional electronic payment systems, where the transaction is first reported to a credit card provider (for example) and then a number of weeks later the retailer is sent the funds from the credit card provider. Therefore, the cash flow of the retailer is improved. The instant transfer of funds between the account holder and the retailer also removes the possibility of the retailer experiencing a charge back payment denial from the account holder against the retailer, as is possible in conventional payment arrangements.

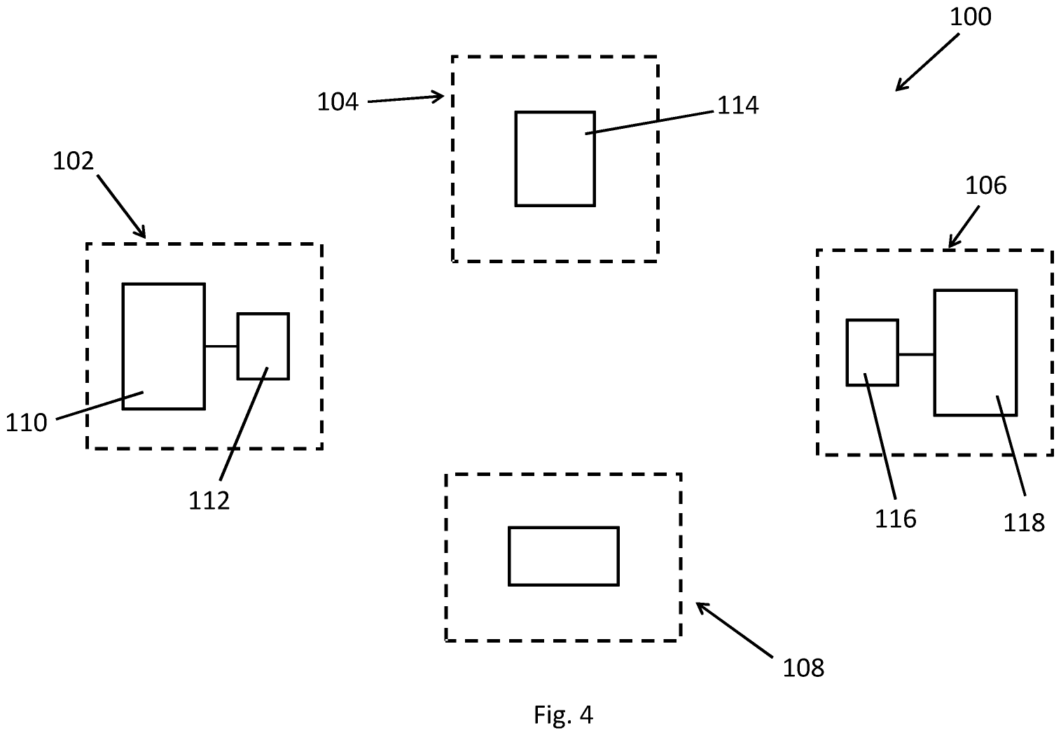

FIG. 4 is a schematic representation of the payment system 100 as described above, including representations of the various apparatus involved and the ways in which the apparatus interacts. The payment system 100 comprises an account holder 102, an account provider 104, a retailer 106, and a high street bank 108. The account holder 102 has a mobile phone 110 on which an application 112 has been installed. The account provider 104 has a server unit 114 which includes account information for all users of the payment system, including the identity of the various users and the funds available in their accounts. A retailer 106 has a point of sale unit 116 linked with a till 118. The point of sale unit comprises an optical reader, configured for reading QR codes. Alternatively or additionally, the point of sale unit may be configured for reading barcodes or other designated input mechanisms.

The various elements of the payment system 100 interact as follows. The mobile phone 110 of the account holder 110 is configured to wirelessly communicate with the server unit 114 of the account provider 104. The communication may include details of the transactions carried out using the mobile phone 110, and allow up to date account information, including funds available, to be displayed when using the application 112 on the mobile phone 110. The application 112 may be loaded with funds via a cash transfer from the high street bank 108, initiated by the account holder using a “load funds” function of the application 112. When in a portrait configuration, the application 112 of the mobile phone is configured to display account information to the account holder. On turning the phone 110 to a landscape orientation, the application 112 generates a unique QR code, which is shown on the display of the mobile phone 110. The unique QR code includes the 16 digit account number of the account holder. In alternative arrangements, the application may generate other types of suitable optically readable codes. The optical reader of the point of sale unit is arranged to read the unique QR code when the mobile phone screen is presented to the reader. The optical reader of the point of sale unit will recognise the 16 digit code of the account holder as an account held with the account provider 104. When the mobile phone screen is presented to the reader, a transaction is initiated. The retailer enters the transaction value into the till, and the point of sale reader transmits the transaction value to the application 112. In alternative arrangements, the account holder may enter the transaction value directly into their mobile phone. The application 112 is configured to request confirmation from the account holder that the transaction is legitimate. Assuming the answer is that the transaction is legitimate, the application 112 then wirelessly transfers the funds from the application 112 to the retailer 106. The wireless transfer may be by any suitable wireless electronic communication protocol or technique. The retailer may then send the money stored in the virtual wallet to a conventional high street bank 108.

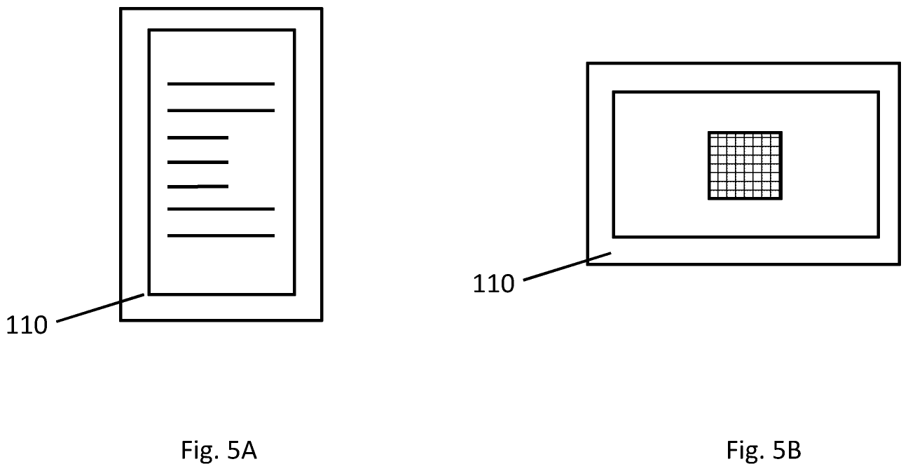

FIG. 5A shows the mobile phone 110 in a first, portrait, orientation, in which the application 112 displays various account information details, including but not limited to: the account number, the account name, the funds available, the funds spent that day, and the last few transaction details. FIG. 5B shows the mobile phone 110 in a second, landscape, orientation, in which the application 112 has generated a unique QR code and is displaying that code on the mobile phone screen 110 in such a way that can be read by an optical reader of a point of sale reader 116. When in the second, landscape orientation, the mobile phone does not display personal account information such as that displayed when the mobile phone is in the first, portrait, orientation.

Whilst the present invention has been described and illustrated with reference to particular embodiments, it will be appreciated by those of ordinary skill in the art that the invention lends itself to many different variations not specifically illustrated herein. By way of example only, certain possible variations will now be described. The above described systems concerns payments made between a customer and a retailer. However, the system may be equally applicable to payments between two personal account holders, each having a phone including the application. Rather than the payment QR code being read by a point of sale reader, the camera on a mobile phone may be used to read the payment QR code, and the cash transferred between the two mobile phones. Whilst QR codes have been described, the skilled person will realise that any suitable optically readable code may be used.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. An apparatus for conducting a financial transaction, the apparatus comprising a smart device with an application,
the smart device having a first configuration in which the application displays account information, and a second configuration in which the smart device displays an optically readable transaction authorisation code,
wherein the transition between the first configuration and second configuration is effected by changing the orientation of the smart device.

2. Apparatus as claimed in claim 1, wherein the smart device is a smart phone.

3. Apparatus as claimed in claim 1 or 2, wherein the optically readable transaction authorisation code is a quick-response (QR) code.

4. Apparatus as claimed in any preceding claim, wherein the smart device is configured such that changing the orientation of the smart device causes the application to generate the optically readable transaction authorisation code.

5. Apparatus as claimed in any preceding claim, wherein the smart device is configured to communicate with a remote server in response to the orientation of the smart device being changed.

6. Apparatus as claimed in any preceding claim, wherein the smart device is configured such that the application is only opened in response to a unique security input by a user.

7. Apparatus as claimed in any preceding claim, wherein the transaction authorisation code is a single use, unique, code.

8. A method of conducting a financial transaction using a smart device, the method comprising:
providing a smart device including an application, the application including financial data,
with the smart device in a first orientation, a user opening the application in a first configuration, the first configuration such that financial information is displayed by the smart device,
the user changing the orientation of the smart device into a second, different, orientation, thereby moving the smart device into a second configuration such that an optically readable transaction authorisation code is displayed by the smart device,
the user presenting the smart device in the second configuration to a point of sale optical reader,
the point of sale optical reader reading the optically readable transaction authorisation code, whereby a financial transaction between the smart device and point of sale optical reader is authorised.

9. A payment system, the payment system comprising:
a smart device including an application, wherein the application is configured such that in response to a user input, the application generates and displays an optically readable transaction authorisation code on the smart device,
a retail unit, the retail unit comprising a point of sale reading device, the reading device configured to read optically readable transaction authorisation codes.
